(19) United States
(12) Patent Application Publication
(10) Pub. No.: US 2012/0310811 A1
(43) Pub. Date: Dec. 6, 2012

(54) SYSTEM AND METHOD FOR REDUCING CURVE RISK

(76) Inventor: UMESH SUBHASH PATEL, Singapore (SG)

(21) Appl. No.: 13/483,315

(22) Filed: May 30, 2012

(30) Foreign Application Priority Data
Jun. 1, 2011 (SG) 201103963-3

(51) Int. Cl. G06Q 40/04

(52) U.S. Cl. 705/37

(57) ABSTRACT

A bond matching system receives positions from dealers identifying bonds to be matched and including the price value per basis point (PVPB) of the bonds and an indication of a percentage deviation from PVBP that the dealer is willing to accept in a matching bond. A matching engine performs a matching optimization during a run to match as many positions as possible and then calculates a series of hedge trades for each dealer to reduce the curve risk generated by matching with bonds having different maturity dates. The hedge trades are executed in a liquid external market such as a futures exchange.

### FIELD OF THE INVENTION

This invention relates generally to the trading of financial instruments and more specifically to the trading of instruments such as bonds and reducing the curve risk generated when there is a mis-match in maturity dates between an instrument that is sold or bought in place of another that is bought or sold.

### BACKGROUND TO THE INVENTION

In the bond markets it is well established practice to execute a hedge trade when a bond is bought or sold if no change in outright risk is desired. Current market practice is for a bond trade to be hedged with a single futures trade in the opposite direction. The future used to hedge a particular bond is based upon publicly available data and is chosen from the most liquid markets to maximise the chance of execution. However, unless the maturity date of the futures trade is the same as that of the bond maturity date, the hedge will give rise to curve risk which is the risk associated with a shift in the yield curve between the maturity dates of the two instruments. A similar risk arises when one bond is bought or sold and another is sold or bought and it is established practice to hedge each of the trades with a futures trade. The purchase of a bond and sale of a future, or vice versa is known as a basis trade.

It is desirable for a trader to be able to eliminate or reduce curve risk caused by maturity date mismatches. Although systems are known which can address the problem, they are not used in the bond markets. There is presently no standardised way of managing curve risk in the bond markets and it is left to individual dealers to work out strategies for dealing with curve risk. In other markets, one known system is the RESET system provided by Reset Pte Limited of Singapore. This is a FRA trading system that uses a combination of offset matching and hedging to reduce risk in the FRA (Forward Rate Agreement) markets. However, When considering risk, the FRA markets only consider the notional rather than the overall position. Moreover, the maturity terms of FRAs is short, being traded in multiples of three months and rarely exceeding a year, whereas bonds may have maturity dates many years in the future, potentially up to fifty years. It is therefore desirable to be able to reduce curve risk generated by a trader when conducting bond trades and to provide a methodology and a system for implementing that methodology that improves on the present practice of basis trades.

### SUMMARY OF THE INVENTION

The invention aims to reduce the curve risk generated by bond trades in which long and short positions do not have the same maturity date. In a first aspect of the invention a computerised bond hedging system comprises a position store for receiving from a plurality of dealers bond positions to be hedged. The bond positions including an identification of one or more bonds, a measure of the value of each bond and an indication of a range of values of bonds with which the dealer is willing for one or more bonds in his position to be matched. A matching engine executes a matching optimisation on the received positions from the plurality of traders to identify a series of matches between positions entered by dealers, the matching optimisation matching buy positions with sell positions and being based on the identification of the bonds, the value of the bonds and the expressed range of values within which each party to the match is willing for bonds to be matched. A hedging calculation module calculates from the series of matches, one or more hedge trades for each dealer for reducing curve risk generated by the matches identified by the matching optimisation.

The indication of a range of values comprises a single indication for all bonds in the position entered by the dealer. Alternatively, the indication of a range of values may comprise an individual indication for each bond or groups of bonds in the position entered by the dealer.

Preferably the value of the bonds is expressed as price value per basis point (PVBP). The indication of a range of values may be expressed as a percentage of PVBP.

Preferably the one or more hedge trades are futures trades. The futures trades may be exchange traded contracts. The hedge trades may be bond trades, for example Cheapest to Deliver (CTD) bonds. The hedge trades may have a maturity date before and after the maturity date of the position to be hedged and the relative amount of each hedge trade may calculated on the basis of maturity date or PVBP.

Preferably the matching optimisation performed by the matching engine calculates an aggregate curve risk for each dealer generated by the matching process and the hedge trades are calculated by the hedging calculation module on the aggregated curve risk. Preferably, the matching engine executes the matching optimisation a plurality of times. This may enable the system to take into account new positions entered into the system by dealers and so ensure the maximum number of matched positions.

In another aspect of the invention a computerised hedging system for hedging a position in one or more financial instruments comprises a position store for receiving from a plurality of dealers positions in the financial instrument to be hedged, the positions including an identification of one or more financial instruments, a measure of the value of each financial instrument and an indication of a range of values of counterparty financial instruments with which the dealer is willing for one or more financial instruments in his position to be matched. A computerised matching engine retrieves the dealers' positions from the store and executing a matching optimisation on the received positions from the plurality of traders to identify a series of matches between positions entered by dealers, the matching optimisation matching buy positions from dealers with sell positions from counterparty dealers on the basis of matching criteria comprising the identification of the financial instruments, the value of the financial instruments and the expressed range of values within which each party to the match is willing for bonds to be matched. Preferably the hedging calculation module calculates the hedge trades required by each dealer on the basis of an aggregated risk position for the dealer after the matching optimisation.

A further aspect of the invention resides in a computerised bond hedging system comprising a position store for receiving from a plurality of dealers' bond positions to be hedged, the bond positions including an identification of one or more bonds, and a measure of the value of each bond. A matching engine executes a matching optimisation on the received positions from the plurality of traders to identify a series of matches between positions entered by dealers, the matching optimisation matching buy positions with sell positions and being based on the identification of the bonds and the value of the bonds. A hedging calculation module calculates from the series a matches, one or more hedge trades in a exchange tradable market for each dealer to reduce curve risk generated by the matches identified by the matching optimisation.

The one or more hedge trades may be futures trades. The futures trades may be exchange traded contracts. The hedge trades may be bond trades, for example Cheapest to Deliver (CTD) bonds. The hedge trades may have a maturity date before and after the maturity date of the position to be hedged and the relative amount of each hedge trade may be calculated on the basis of maturity date or PVBP.

Embodiments of the invention have the advantage that dealers can execute hedge trades in a manner that enables them to control curve risk and therefore meet curve risk targets as well as other trading risk targets. The use of a curve range may greatly increase the efficiency of the matching process making many more matches possible and so enabling more positions to be closed.

### BRIEF DESCRIPTION OF DRAWINGS

Embodiments of the invention will now be described, by way of example only, and with reference to the accompanying drawings in which:

FIG. 1 illustrates the difference between maturity dates of two bonds;

FIG. 2 illustrates how curve risk may be reduced in the trading of bonds with different maturity;

FIG. 3 illustrates a dealer sheet listing bond positions that a dealer wishes to close;

FIG. 4 illustrates, schematically, a trading system embodying the invention;

FIG. 5 illustrates the effect of curve range in the matching of positions, given a range of 10%;

FIG. 6 illustrates how a long and short bond positions can be hedged by three futures trades;

FIG. 7 illustrates the hedging of a single bond by two weighted futures trades; and

FIG. 8 is a table showing an example of netting hedges in the futures market;

Before describing an electronic system which matches and hedges bond positions, it is useful to understand the nature of trading risk that bond traders wish to minimise.

Bond trading involves three primary risks: outright (or directional), credit (or issuer) and curve risks. The outright risk is the trader's exposure to market variables; credit risk refers to the risk of an issuer defaulting before a bond matures and curve risk refers to the risk of an adverse shift in market rates which causes a flattening or steepening of the yield curve resulting from changing yields among comparable bonds with different maturities. When the yield curve shifts, the price of the bond, which was initially priced on the initial yield curve, will change. If the curve flattens, the spread between long and short term interest rates narrows and the price changes accordingly. If the curve steepens, the spread between long and short term interest rates increases and long term bond prices decrease relative to short term bonds.

A bond dealer who understands the various types of trading risk will attempt to set up his positions so that his portfolio meets a target level of each of these types of risk.

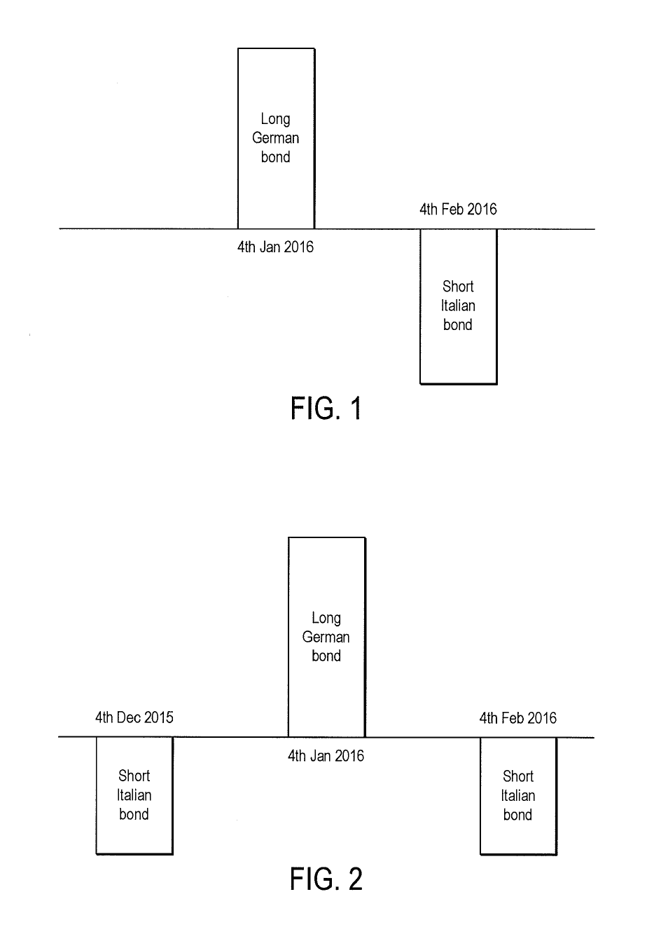

FIG. 1 illustrates an example of how curve risk develops. Here two bonds are illustrated, a German bond (DBR a German Government Bond) 100 having a maturity date of 4 Jan. 2016 and an Italian bond (BTPS an Italian Treasury Bond) 110 having a maturity date of 4 Feb. 2016, one month after that of the German bond. In this example the dealer believes that German Government bonds will appreciate in value compared to Italian bonds. He therefore buys German bonds (or goes long) and sells (or goes short) Italian bonds. The amount of the Italian bond that is sold is a PVBP (Price Value of a Basis Point) weighted amount so as to negate any outright risk. Ideally, the bonds would have the same maturity date. However, in this example there is no Italian bond maturing on 4 Jan. 2016 and the closest maturity date that can be sold is 4 Feb. 2016.

If we now assume that the German bond has a PVBP of 5.5 and the Italian bond has a PVBP of 6.00, the total risk for 100 m of the DBR for January 2006 is 55,000 (PVBP*quantity/10,000). In order to make the switch outright neutral, the BTPS for February 2016 position risk must also equal 55,000. The amount is therefore equal to 10,000*risk/PVBT giving 91.67 m. Thus, 100 million of the DBR bond maturing on 4 Jan. 2016 is equal to 91.67 million of the BTPS bond maturing on 4 Feb. 2016.

The two bond maturities are mis-matched by one calendar month. This difference is the curve risk of the trade. The dealer has created a credit or issuer risk intentionally, has not created any outright risk, and has inadvertently created a curve risk. In order to negate this curve risk, another bond must be sold which has a maturity shorter than that of the German bond to equalise the curve risk. This is illustrated in FIG. 2. Here, a second Italian bond 120 having a shorter maturity than the German bond is sold to equalise the curve risk. In this example, for simplicity, the second short Italian bond is shown as having a maturity one month shorter than the German bond so that each short bond is the same distance away from the long bond.

The distribution between the two short Italian bonds may be weighted according to the time from the target date, that is the relative differences in maturities compared to the long bond. In this case, that weighting would result in a 50:50 weighting such that the dealer would sell equal amounts of the 4 Feb. 2016 Italian bond and the 4 Dec. 2016 Italian bond. Alternatively, the weightings for the quantity of each bond can be according to the PVBP of the two bonds. Thus, although the two bonds have maturity dates which are an equal distance from the target date, if their PVBPs are different, the weighting is according to those PVBPs. A combination of both maturity date and PVBP could also be used.

In practice, the bonds selected to negate the curve risk will be bonds that are considered to be the most liquid at the time of the run as these are the bonds that have the greatest chance of being traded. These bonds will usually, but not necessarily, be two year, three year, five year and ten year benchmarks. Although a trader will work out the offset trades needed to negate curve risk, he still relies on the market being able to execute those trades. If there is no matching trade to be found the risk is not offset. Thus the trader seeks to offset in the most liquid instrument available to him.

In this simple example, the trade is an issuer risk trade with one Government bond being traded against another (German against Italian). In practice, most inter-dealer trades will be basis trades in which a bond position is hedged with a futures trade. At present, it is current practice for a bond trade to be hedged with a single futures trade in the opposite direction. The future used to hedge a particular bond is based on publicly available data.

According to one aspect of the present invention, an electronic system provides curve hedging based on a hedge instrument, for example two futures contracts in a manner described with respect to FIG. 2. Thus, the weighting of the futures contracts may be based on the maturity date of the future and/or the PVBP of the future.

A future may be considered a theoretical bond that does not actually exist. It is also a proxy for an actual bond at a given moment in the future. The proxy bond is called the cheapest to deliver (CTD). When referring to the future, one can use either theoretical bond parameters such as PVPB, maturity and issuer, or the CTD parameters.

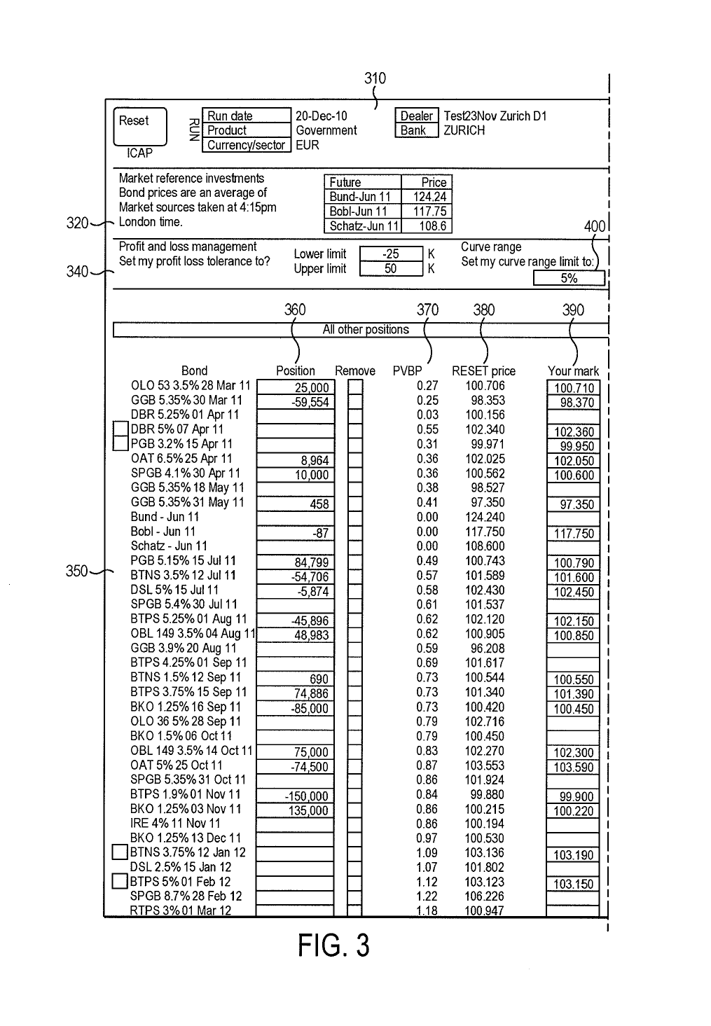

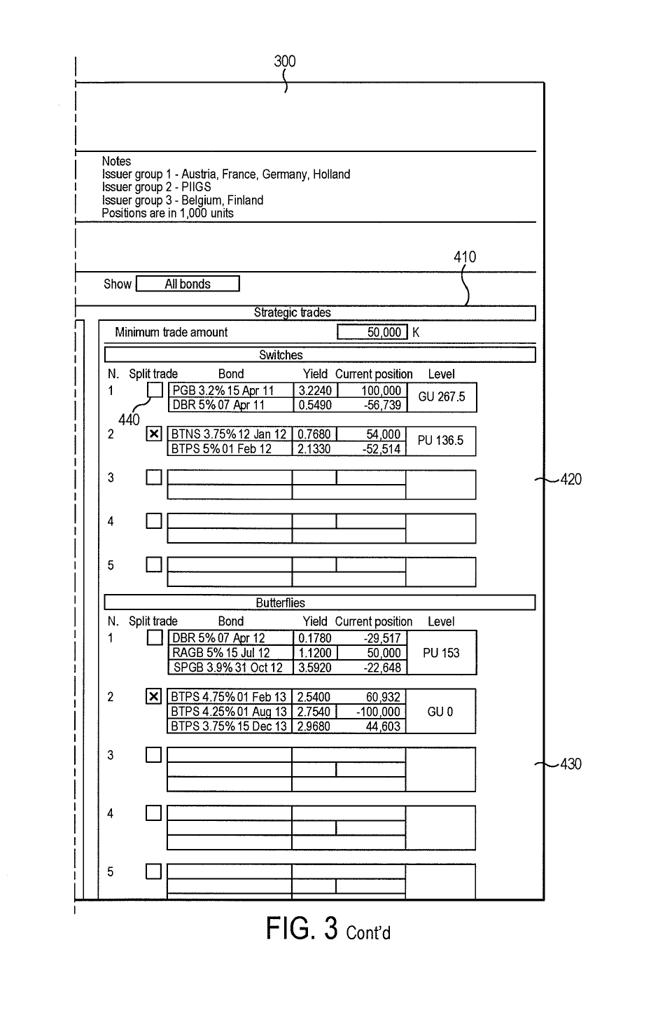

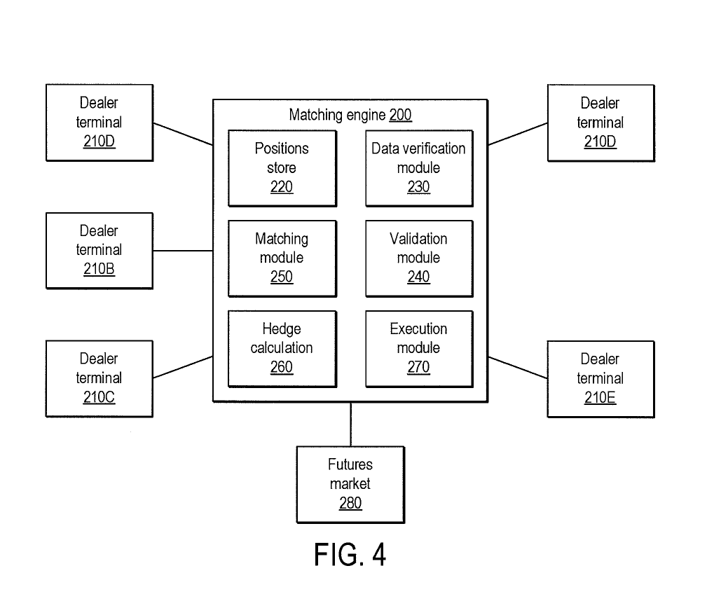

A system embodying the invention will now be described. FIGS. 3 and 4 show aspects of a system embodying the invention. FIG. 3 shows a list of positions which a dealer wishes to hedge and which is submitted to the system shown in FIG. 4. The system comprises a central matching engine 200 to which the traders A-E are connected. The matching engine may be any suitable computer system running appropriate matching software. An example is the RESET matching system operated by RESET PTE Limited of Singapore. The traders A-E may communicate with the matching engine 200 via trader terminals 210 A-E which may be conventional PCs and the communications may be via the Internet or through a dedicated communications network. The list of positions sent by traders may be sent via a web page or as an e-mail or in some other convenient form to be input automatically into the system. Alternatively, the list of positions may be sent by facsimile to the matching engine to be input manually into the matching engine on receipt.

FIG. 3 shows a dealer sheet 300 on which the dealer enters the positions that they wish to trade. The matching engine will perform a run at specified times for specified bonds. As can be seen from panel 310 in the top left hand corner a run identification area lists the date of the run to which the bonds relate together with the product, in this case, Government bonds, and the currency or market sector, in this case the Eurozone. The dealer and the bank that the dealer represents are also indicated.

Beneath the run identification area is a market reference area 320 which includes a listing 330 of futures which may be used to hedge the bonds listed by the dealer. Although futures are the presently preferred hedge instrument, other hedge instruments may be used. For example, bonds may be used as a hedge instrument. In this case three futures are listed as the hedge instruments: Bund, Bobl and Schatz, each having a June 2011 maturity date. The price is listed next to the future. The three futures listed are the most actively traded fixed-income securities in the European Government Bond market and therefore ideally suited to hedging as they are very liquid. These are merely examples of suitable futures for the hedge and others may be used as appropriate.

Beneath the market reference instruments area is a profit and loss management and curve range panel 340, the values of which are defined by the dealer. These will be described in due course.

In the left hand main part of the display 350, a listing of bonds that the dealer wishes to trade is given. In the present example, the listing contains all bonds which can be matched in this market sector and the dealer enters the amount they wish to trade of any given bond in a position column 360. The PVBP of each bond is shown in column 370 and the price in column 380. The dealer's mark or target price is entered by the dealer in column 390.

On the right hand side of the display is listed a dealer's strategic trades in a panel 410. This panel is divided into two parts: Switches 420 and Butterflies 430. The bonds which are listed in these sections are ones which the dealer wishes to trade together, that is they are linked orders. A switch involves the buying of one bond and the selling of another. The dealer does not want to complete only one leg of the trade and so the system will either execute both parts or neither. The switch panel identifies the two bonds and requires the dealer to enter the amount of one only. As the system knows the PVPB of that bond it can automatically calculate the amount needed of the other bond. In the first of the switches listed in FIG. 3 the dealer enter an amount of 100,000 of bond PGB 3.2% 15 Apr. 2011 and enters the other bond of the pair: DBR 5% 7 Apr. 2011. The dealer spreadsheet then automatically calculates that amount of 56,739 of the DBR 5% 7 Apr. 2011 bond is required to be sold.

The dealer may indicate that a split trade is acceptable by checking a box 440 next to the switch. This indicates that the dealer prefers both legs of the switch to be traded together but would accept a trade of one leg if the switch cannot be made.

The butterfly panel 430 is essentially the same as the switch panel 420 and also has the option to split the trade. A butterfly comprises a main body trade with two wings either side in terms of maturity date. Thus in the first of the butterflies shown, the body is a 50,000 buy of RAGB 5% 15 Jul. 2012 and the wings are sells of bonds having a maturity date of 7 Apr. 2012 and 31 Oct. 2012 respectively. The wings are risk weighted 50/50 in accordance with market convention. As with the switch example, the dealer will enter the amount of the body trade and the dealer spreadsheet will calculate the amounts of the wing trades needed from the PVPB, and in this case, the weighting ratio, when these positions are loaded into the system they are verified again to ensure correct calculations.

Preferably, once filled in by the dealer, the sheet is transmitted via email to the matching engine 200 at which the positions are automatically entered into the system and stored in memory 220. This automatic loading will include a verification step in which a verification module 230 forming part of the matching engine examines the data in the spreadsheet to verify that it is entered in the correct places and in the correct formats. For example, the conventions for expressing the volume of a bond vary from market to market and may be expressed in multiples of one thousand. In FIG. 3, the first position is listed as 25,000 which, under this convention, equates to a volume of 25,000,000. When the data has been verified and loaded a validation module 240 forming part of the matching engine will perform validation tests against stored criteria.

It is preferred that the positions are input directly into the matching engine In the email example mentioned above, the positions spread sheet is sent from the system to dealers and the completed spreadsheets returned by the dealers. As the data in the spread sheet is in a format known to the system the positions data can be extracted automatically from the spreadsheets and stored in the system. Alternatively, positions may be entered directly via a web page or through an Internet portal or through a third party position holding system. A dealer may send information to a service provider through their bank's infrastructure.

A run will typically occur once every few weeks but will depend on the instrument. Initially, the run seeks to match positions via a matching module 250 entered by different traders which can be netted off against the participants. Thus, one party wishing to sell an amount of a given bond can be netted off against another party that wishes to buy the same amount of the same bond. In practice, the amounts will often not be the same and the matching engine will optimise the matching process. As the run time approaches and dealers enter their positions, the matching engine will successively run the matching process and further refine the match as further positions are entered. The match may be run multiple times over a period of, for example, three or four hours or even up to seven or eight hours for a big run. During this time, potential matched orders are monitored.

During the optimisation process the matching engine looks at every position and attempts to make as many matches as possible between opposite positions. The optimisation algorithm is performed several times commencing when traders have input position sheets and being rerun as further positions are entered. The optimisation algorithm looks at all possible matches and combinations of matches that can be made and reaches a final stage in which the best combinations of matches are determined which net out as many positions as possible. The matching process begins when two or more dealers have entered positions and is run many times as new positions are entered. A run may take several hours to complete.

Once the optimisation process is completed, the risk will be aggregated and expressed in benchmark/futures equivalents. This task is performed by hedge calculation module 260 in FIG. 4. A hedge is then performed. As the optimisation is outright neutral, any curve hedges will also be neutral. As mentioned above, the hedge instrument may not be a future and, in that case, the communication will be with a suitable market for the hedge instrument. In practice, the hedging module may not communicate with the market directly but may be responsible for communicating details of the matched positions and the hedges to a third party which will then arrange for the creation and execution of the necessary trades.

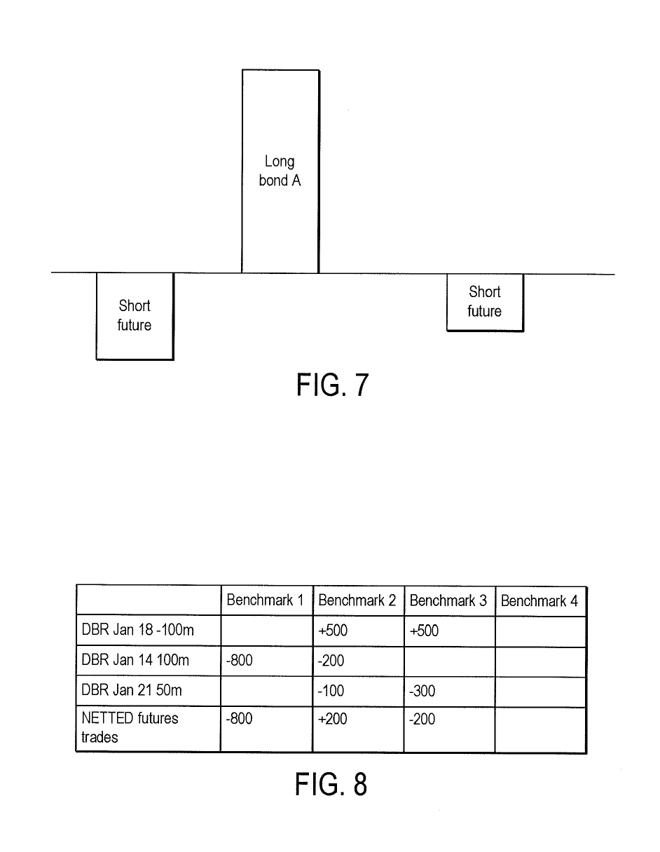

Referring back to FIG. 3, the dealer may enter a curve range limit in field 400 of the spread sheet. This curve range limit is expressed as a percentage and represents the extent to which a match must be identical for the optimisation process to match two bonds together. The percentage is preferably a percentage of PVBP of the bonds although other parameters many be used. This is explained further with respect to FIG. 7.

The curve range process is implemented prior to execution of the matching and optimisation algorithm by the matching engine. As is clear from FIG. 3, dealers' positions are loaded into the system using the PVBP of each bond and the dealer provided curve range, which will be the same for all bonds in their position. From this information the matching engine can calculate pairs of possible trades. Alternatively, individual curve ranges may be specified for individual bonds or groups of bonds.

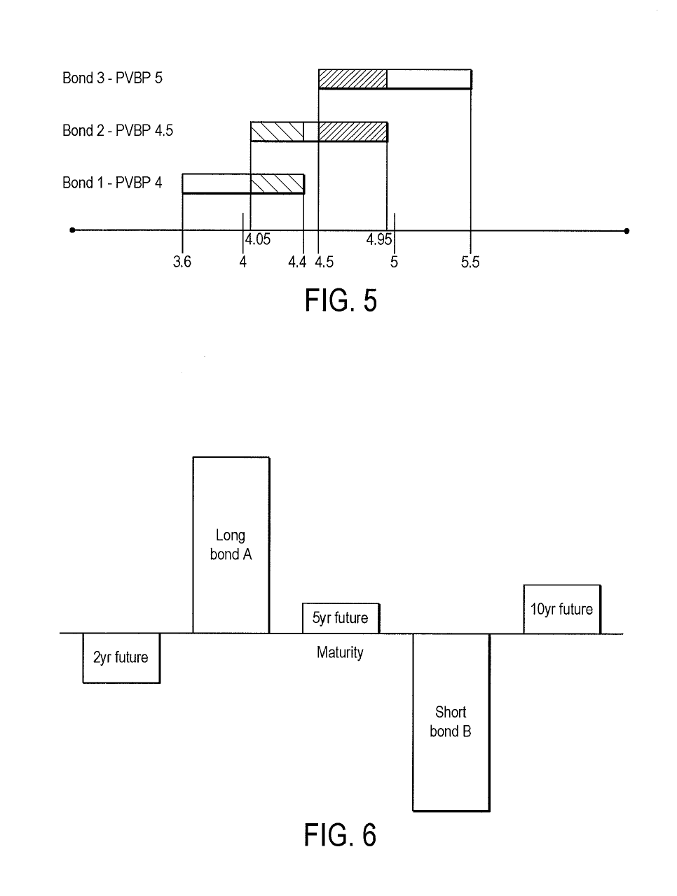

FIG. 5 shows an example in which a dealer has entered a curve range of 10%. Consider three bonds: bond 1 has a PVBP of 4. The curve range for that bond will be 10% either side of that PVBP; that is 3.6-4.4. Thus, the bond can be matched with opposite positioned bonds having a PVBP (or PVBP Range overlap) of between 3.6-4.4. Thus the curve range is an expression of the amount of mismatch, here expressed in terms of PVBP that the dealer is prepared to accept in order to achieve a match.

Bond 2 has a PVBP of 4.5 and therefore has a range 4.05-4.95. Bond 3 has a PVBP of 5 and a range of 4.5-5.5. In this example, the three bonds have been input by different dealers all of whom are using the same parameter although this could be the same dealer.

FIG. 5 shows the three bonds and their PVBP and the curve range for the three bonds. It can be seen that bonds 1 and bonds 2 overlap and that bonds 2 and 3 also overlap. Thus, the matching engine can make possible pairings, or potential deals, between bond 1 and bond 2 and bond 2 and bond 3 as the pairs have a part of their range in common.

These pairings are conditional as bond 2 can only be used to the maximum position, or amount provided. Thus, there may be a partial trading of both pairs totalling the maximum amount of bond 2 provided by the submitting trader. Alternatively, the maximum amount may be traded in one of the pairings such that the other pairing is no longer available. If the full volume of bond 2 is not traded in one of the pairings, the remainder is available for the other pair. Thus, for any particular bond, the match may be with more than one other position up to the maximum of the bond.

Thus, each position has a PVBP band created using the bond's PVBP and the curve range provided by the dealer. In the example shown the curve range provided by the dealer is the same for all bonds in the portfolio. However, this need not be the case and individual curve ranges may be submitted for a given bond or groups of bonds. This band defines which other bonds can be used to hedge the position and all potential pairings are input into the system to calculate the optimum result for all dealers. It has the advantage of ensuring that the curve risk is not greater than the dealer had anticipated.

Thus, the number of possible matches found by the matching engine will depend on the curve ranges that are input by the dealers with their positions. For the reasons explained above the matching engine will make many matches all of which cannot be executed and the optimisation process seeks to determine the best possible set of matches that minimises the number of positions left unmatched, or maximise the volume transacted at the end of the run.

It is not necessary that curve range is selected for both bonds for a match to be made. For example, if one bond has 10% curve range selected and a PVBP of 4, the range will be 3.6 to 4.4. It can be matched with a bond that has no curve range selected by the dealer and a PVBP fall within the range, say 4.2.

A single Curve Range may specified by the dealer, and the Curve Range applied to one bond, be it the Longer or Shorter maturity bond or Higher/Lower PVBP bond, to ascertain a range that can then be used to identify another bond. This, if the Curve Range is applied only the lower PVBP bonds, by way of example, Bond 1, has a PVBP of 4, with a Curve Range of 10%. That position can be hedged with a bond within that range, say Bond 2 which has a PVBP of 4.2. Bond 2 can then be used for another potential trade, creating a range of 3.78-4.62, but the other bond would have to have a absolute PVBP between 4.2-4.62. with Bond 2 being the shorter maturity bond.

Once the optimisation has take place and the risk aggregated and expressed in Benchmark/Futures equivalent, the curve hedging process takes place. This is explained with reference to FIGS. 6 and 7. FIG. 6 illustrates a long bond A which is matched with a short bond B having a different maturity date. The two bond trades are expressed as netted 2 year, 5 year and 10 year risk points. In order to eliminate the resultant curve risk from the two bond trades, the three trades shown in green need to be performed. These are all futures trades and are outright neutral as the two bond trades are also outright neutral. For each bond there will be a futures trade both before and after the maturity date. However, the two trades between the dates of the bond can be aggregated into a single trade.

If there is no curve range in the run, there may be potential only to do one bond trade that is hedged with one or more futures as shown in FIG. 7. Indeed, there may be only a single futures trade when the bond and future match exactly either in terms of PVBP or maturity terms.

The curve hedging is calculated after the matching optimisation takes place. The matching results in the trading off of positions against one another dependent on PVBP and curve range. The resultant curve risk is then hedged by the series of futures trades. The matching engine matches as many positions as possible regardless of the curve impact. If a dealer chooses not to specify a curve range, the raw position data only is passed to the engine for execution. Each potential trade is broken down into its benchmarks equivalents which, as discussed, may be other bonds or futures but are hedging trades which the system considers most suitable to hedge the curve and are preferably the most liquid instruments on that particular bond curve. Each potential trade is displayed in terms of two points that should limit the risk from the potential trade.

The benchmark equivalent could be netted across all potential trades, giving a single trade in each benchmark negating most of the risk from all the potential trades. This is particularly effective where the hedge instrument is a future as different bonds can be hedged using the same futures and, depending on the market in which the futures are traded, there will only be a limited number of futures available.

An example of the curve hedging process is shown in FIG. 8. In the first column 400 are shown three trades all in DBR bonds with different maturity dates. The first trade, is a 100,000,000 sale (indicated by the negative sign); the second is a 100,000,000 purchase and the third a 50,000,000 purchase. In order to hedge against the first trade, two benchmark trades of plus 500 are conducted in a second and a third benchmark, these are buy trades either side of the January 18 date similarly, the second trade is hedged by a minus 800 trade in a first benchmark and a minus 200 trade in a second benchmark and the third bond trade is hedged by a minus 100 trade in the second benchmark and a minus 300 trade in the third benchmark. Thus, the three benchmark trades may be netted to provide a minus 800 requirement in the first benchmark, a plus 200 requirement in the second benchmark and a minus 200 requirement in the third benchmark. These trades are performed in a suitable futures market as illustrated in FIG. 4 and the results of the trade communicated back to the matching engine and then onwards to the traders. The trades may be created and executed from a remote location from the system based on trade information provided by the system. The trades may not be executed by the system itself.

It will be seen from the above discussion that each bond position will have two futures executed against it. As mentioned above, the weightings of the futures may either be based on PVBP or maturity date. The weightings are used to apportion the Principal to the corresponding future. With the appropriately weighted principal amounts known, the amount to be hedged can be converted into a number of futures contracts.

In one preferred embodiment, the system calculates the matches and the netted hedges but is not responsible for their execution. The system may send details of the trades required to a third party for creation and execution of the trades. Alternatively, the system may be responsible for execution in which case it causes the trades to be performed. In the case of the hedge trades, where the hedge is a future, the trade must be made on an exchange. Where the hedge is a bond, the trade may be performed in an OTC (over the counter) market.

As discussed above, the optimisation process is run may times as new positions are added by traders. It is preferred, but not essential that each time the matching optimisation is run, the curve hedging and netting is also calculated. Subsequent runs may build on the results of previous runs, but it is preferred that each run discards the previous results and starts again to maximise the chances of the best matches being made.

Many variations to the embodiments described are possible and will occur to those skilled in the art without departing from the scope of the invention which is defined in the following claims.

1. A computerized bond trading system comprising:
a position store for receiving from a plurality of dealers bond positions to be traded, the bond positions including an identification of one or more bonds, a measure of the value of each bond and an indication of a range of values of bonds with which the dealer is willing for one or more bonds in his position to be matched;
a matching engine for executing a matching optimization on the received positions from the plurality of dealers to identify a series of matches between positions entered by dealers, the matching optimization matching buy positions with sell positions and being based on the identification of the bonds, the value of the bonds and the expressed range of values within which each party to the match is willing for bonds to be matched; and
a hedging calculation module for calculating from the matched positions, one or more hedges in a hedge instrument for reducing curve risk generated by the matched positions.

2. The system according to claim 1, wherein the indication of a range of values comprises a single indication for all bonds in the position entered by the dealer.

3. The system according to claim 1, wherein the indication of a range of values comprises an individual indication for each bond or groups of bonds in the position entered by the dealer.

4. The system according to claim 1, wherein the value of the bonds is expressed as price value per basis point (PVBP).

5. The system according to claim 4, wherein the indication of a range of values is expressed as a percentage of PVBP.

6. The system according to claim 1 wherein the hedge instrument for the one or more hedges hedge-trades is futures.

7. The system according to claim 6, wherein the futures trades are exchange traded contracts.

8. The system according to claim 1, wherein the hedge instrument for the hedge trades is bonds.

9. The system according to claim 1, wherein the hedge trades have a maturity date before and after the maturity date of the position to be hedged and the relative amount of each hedge trade is calculated on the basis of maturity date.

10. The system according to claim 1, wherein the hedge trades have a maturity date before and after the maturity date of the position to be hedged and the relative amount of each hedge trade is calculated on the basis of PVBP.

11. The system according to claim 1, wherein the matching optimization performed by the matching engine calculates an aggregate curve risk for each dealer generated by the matching process and the hedge trades are calculated by the hedging calculation module on the aggregated curve risk.

12. The system according to claim 1, wherein the matching engine executes the matching optimization a plurality of times.

13. The system according to claim 1, wherein the received bond positions include at least one linked order having a plurality of legs and the matching engine is arranged to match all or none of the legs.

14. The system according to claim 13, wherein the matching engine is arranged to match less than all legs of a linked order if it is not able to match all the legs and the received bond position indicates that a partial match is acceptable to the dealer.

15. The system according to claim 13, wherein the linked orders comprise switches.

16. The system according to claim 13, wherein the linked orders comprise butterflies.

17. The system according to claim 1, wherein the hedging execution module executes a pair of hedge trades for each executed matched position.

18. The system according to claim 1, wherein the hedging execution module includes a netting module which calculates a net hedging requirement for each dealer and executes the required hedge in the external market.

19. A computerized trading system for hedging a position in one or more financial instruments comprising:
a position store for receiving from a plurality of dealers positions in the financial instrument to be traded, the positions including an identification of one or more financial instruments, a measure of the value of each financial instrument and an indication of a range of values of counterparty financial instruments with which the dealer is willing for one or more financial instruments in his position to be matched; and
a computerized matching engine for retrieving the dealers' positions from the store and executing a matching optimization on the received positions from the plurality of dealers to identify a series of matches between positions entered by dealers, the matching optimization matching buy positions from dealers with sell positions from counterparty dealers on the basis of matching criteria comprising the identification of the financial instruments, the value of the financial instruments and the expressed range of values within which each party to the match is willing for financial instruments to be matched; and
a hedging calculation module for calculating from the matched positions, one or more hedges in a hedge instrument for reducing curve risk generated by the matched positions.

20. The system according to claim 19, wherein the hedging calculation module calculates the hedge trades required by each dealer on the basis of an aggregated risk position for the dealer after the matching optimization.

21. A computerized bond trading system comprising:
a position store for receiving from a plurality of dealers bond positions to be traded, the bond positions including an identification of one or more bonds, and a measure of the value of each bond;
a matching engine for executing a matching optimization on the received positions from the plurality of dealers to identify a series of matches between positions entered by dealers, the matching optimization matching buy positions with sell positions and being based on the identification of the bonds and the value of the bonds; and
a hedging calculation module for calculating from the series of matches, one or more futures trades in a exchange tradable market for each dealer to reduce curve risk generated by the matches identified by the matching optimization.

22. The system according to claim 21, wherein the hedging calculation module calculates the futures trades required by each dealer on the basis of an aggregated risk position for the dealer after the matching optimization.

23. A computerized bond trading method comprising:
receiving at a computerized matching system, from a plurality of dealers, bond positions to be traded, the bond positions including an identification of one or more bonds, a measure of the value of each bond and an indication of a range of values of bonds with which the dealer is willing for one or more bonds in his position to be matched;
executing at the computerized matching system a matching optimization on the positions received from the plurality of dealers to identify a series of matches between positions entered by dealers, the matching optimization matching buy positions with sell positions and being based on the identification of the bonds, the value of the bonds and the expressed range of values within which each party to the match is willing for bonds to be matched; and
calculating at a hedge calculating module, from the series a matches, one or more hedge trades for each dealer for reducing curve risk generated by the matches identified by the matching optimization.

24. The method according to claim 23, wherein the indication of a range of values comprises a single indication for all bonds in the position entered by the dealer.

25. The method according to claim 23, wherein the indication of a range of values comprises an individual indication for each bond or groups of bonds in the position entered by the dealer.

26. The method according to claim 23, wherein the value of the bonds is expressed as price value per basis point (PVBP).

27. The method according to claim 26, wherein the indication of a range of values is expressed as a percentage of PVBP.

28. The method according to claim 23, wherein the one or more hedge trades are futures trades.

29. The method according to claim 28, wherein the futures trades are exchange traded contracts.

30. The method according to claim 23, wherein the hedge trades are bond trades.

31. The method according to claim 23, wherein the hedge trades have a maturity date before and after the maturity date of the position to be hedged and the relative amount of each hedge trade is calculated on the basis of maturity date.

32. The method according to claim 23, wherein the hedge trades have a maturity date before and after the maturity date of the position to be hedged and the relative amount of each hedge trade is calculated on the basis of PVBP.

33. The method according to claim 23, wherein the matching optimization performed by the matching engine calculates an aggregate curve risk for each dealer generated by the matching process and the hedge trades are calculated by the hedging calculation module on the aggregated curve risk.

34. The method according to claim 23, comprising executing the matching optimization a plurality of times.

35. A computerized trading method for hedging a position in one or more financial instruments comprising:
receiving at a computerized matching system, from a plurality of dealers, positions in the financial instrument to be traded, the positions including an identification of one or more financial instruments, a measure of the value of each financial instrument and an indication of a range of values of counterparty financial instruments with which the dealer is willing for one or more financial instruments in his position to be matched;
executing by a computerized matching engine a matching optimization on the received positions from the plurality of dealers to identify a series of matches between positions entered by dealers, the matching optimization matching buy positions from dealers with sell positions from counterparty dealers on the basis of matching criteria comprising the identification of the financial instruments, the value of the financial instruments and the expressed range of values within which each party to the match is willing for financial instruments to be matched; and
calculating by a hedging calculation module from the series of matches, one or more hedge trades for each dealer for reducing curve risk generated by the matches identified by the matching optimization.

36. The method according to claim 35, wherein the hedge trades required by each dealer are calculated on the basis of an aggregated risk position for the dealer after the matching optimization.

37. A computerized bond trading method comprising:
receiving at a computerized matching system, from a plurality of dealers, bond positions to be traded, the bond positions including an identification of one or more bonds, and a measure of the value of each bond;
executing by a computerized matching engine a matching optimization optimisation on the received positions from the plurality of dealers to identify a series of matches between positions entered by dealers, the matching optimization matching buy positions with sell positions and being based on the identification of the bonds and the value of the bonds; and
calculating by a hedging calculation module from the series a matches, one or more futures trades in a exchange tradable market for each dealer to reduce curve risk generated by the matches identified by the matching optimization.

38. The method according to claim 37, wherein the futures trades required by each dealer are calculated on the basis of an aggregated risk position for the dealer after the matching optimization.
